(19) United States
(12) Patent Application Publication
(10) Pub. No.: US 2008/0139718 A1
(43) Pub. Date: Jun. 12, 2008

(54) POLYMER ADDITIVE COMPOSITIONS AND METHODS

(76) Inventors: Wouter Reyntjens, Oostkamp (BE); Martin Horrocks, Greer, SC (US); Diederik Goyvaerts, Wilsele-Putkapel (BE); Rob Hanssen, Gent (BE)

Correspondence Address: Legal Department (M-495), P.O. Box 1926, Spartanburg, SC, 29304, US

(21) Appl. No.: 11/609,042

(22) Filed: Dec. 11, 2006

(51) Int. Cl. C08K 5/098

(52) U.S. Cl. 524/396

(57) ABSTRACT

Compositions comprising hexahydrophthalate (HHPA) metal salts may be useful as nucleating agents in polyolefins. Masterbatch compositions containing such salts and with additives may be useful in reducing haze and improving properties of manufactured polyolefin articles or film.

### FIELD OF THE INVENTION

This invention relates to compositions of polyethylene containing additives that are capable of providing favorable processing characteristics and qualities to polymer products manufactured with such polyethylene.

### BACKGROUND OF THE INVENTION

Thermoplastics are used in a variety of end-use applications, including storage containers, medical devices, food packages, cast films, blown films, plastic tubes and pipes, shelving units, and the like. To achieve desirable physical properties, certain compounds and compositions provide nucleation sites for polymer crystal growth during molding or fabrication. Generally, compositions containing such nucleating compounds crystallize at a much faster rate and crystallize at high temperature than non-nucleated polyolefins, which is desirable.

Metal salts are useful as nucleating additives for thermoplastics. U.S. Pat. No. 6,599,971 discloses metal salts of HHPA for use in thermoplastics. Other published patents that are commonly owned by the owner of the current application and which relate to metal salt compounds and their use as nucleating agents in polymers include U.S. Pat. Nos. 6,562,890; 6,465,551; 6,642,290; 6,703,434; 6,794,433 and 6,887,963. Other commonly owned patents of interest include U.S. Pat. Nos. 6,936,650 and 6,946,507.

Milliken & Company of Spartanburg, S.C., USA (“Milliken”) markets and sells a nucleating agent composition within its HYPERFORM® nucleating agent additive product line under the designation “HPN-20E™”. The additive product HPN-20E™ contains “Ca HHPA” as shown:

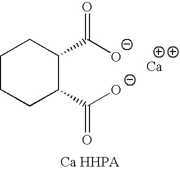

Milliken also markets and sells other compounds as nucleating agents. For example, HYPERFORM® HPN-68L is a powdered solid nucleating agent manufactured by Milliken & Company in which the nucleating agent comprises a dicarboxylate Na-based compound known as HPN-68 L:

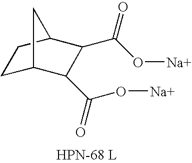

### Cis-endo-bicyclo[2.2.1]heptane-2,3-dicarboxylic acid, disodium salt

Milliken manufactures and sells a masterbatch of the Cis-endo-bicyclo[2.2.1]heptane-2,3-dicarboxylic acid, disodium salt compound under the trademark Hyperform Concentrate HI5-5™, which is a commercially available concentrate in a carrier resin for easy and convenient use. U.S. Pat. No. 6,995,202 describes this masterbatch composition and method.

Reducing haze in thermoplastic materials is highly desirable. In general, the use of co-additives is very unpredictable in the art of applying nucleating agents. It is almost always uncertain what co-additives at what concentrations may be used to improve polymer properties or haze levels. Further, it usually is not predictable what additive interactions may impact additive performance. Sometimes, additives in a polymer react undesirably, reducing the impact of both additives. Other times, one may discover a favorable effect when two additives are combined in a polymer, and such interactions usually are difficult to predict.

It is known in the industry to use the nucleating or clarifying agent HPN-20E™ (from Milliken & Company, also known as “Ca HHPA”) as an additive for the manufacture of polyethylene film. It is believed that such operations have employed at least two separate masterbatch (concentrate) composition streams, i.e. a first concentrate stream having a polymer processing aid (PPA) and a second concentrate stream containing the dicarboxylate nucleating agent HPN-20E™. Such a conventional prior art process may be seen in FIG. 1, in which a PPA is used in one masterbatch, and the nucleating agent/clarifier is used in a separate concentrate or masterbatch. This procedure requires that separate feed streams be used to apply each additive into the resin, which has certain operational disadvantages.

The processing of polyolefins and other polymers into films, sheets or tubes usually takes place by extrusion, wherein the polymer is melted in an extruder and forced through a nozzle into the desired shape. For economic reasons, the highest possible throughput through the extruder is desirable.

One characteristic of concern by such manufacturing process is that the conventional manufacture of polyethylene (“PE’) film sometimes results in a rough surface of extrudate, also known as “sharkskin”. Several measures have been proposed for prevention of this undesired melt fracture. This invention is directed improved polyethylene polymer products, improved processes, and also improved film in terms of surface properties, haze, clarity, or gloss.

### BRIEF DESCRIPTION OF THE DRAWINGS

A full and enabling disclosure of this invention, including the best mode shown to one of ordinary skill in the art, is set forth in this specification, and in FIGS. 2-6 below.

FIG. 1 shows a commercial prior art application of PPA with a nucleating agent HPN-20E™ in two separate masterbatch streams in the extrusion of polymer film;

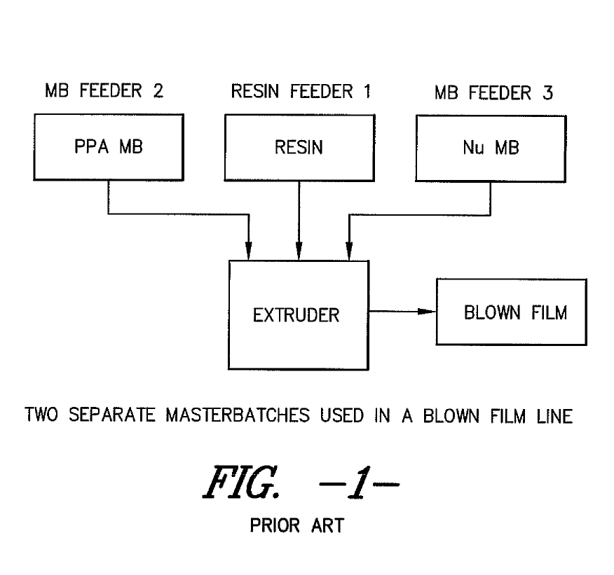

FIG. 2 is a schematic showing the preparation of a single concentrate (i.e. a concentrate containing PPA with the nucleating agent) in the practice of one embodiment of the invention, for use in polymer processing; and

FIG. 3 is a schematic process flow showing a single concentrate containing both the PPA and the nucleating agent, as one embodiment of the invention, which may be applied into a polymer resin in large scale commercial operations in an efficient manner; and

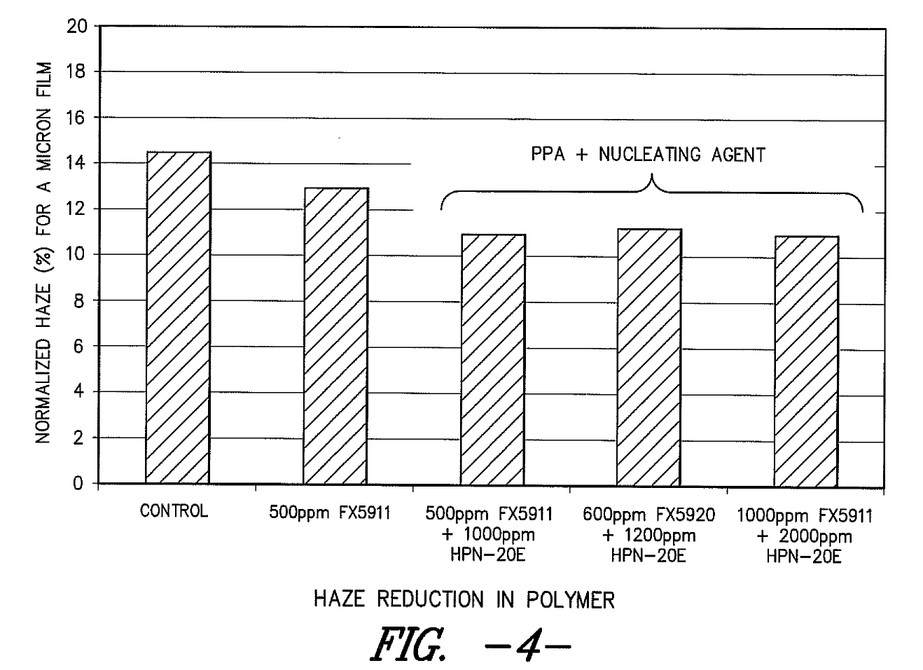

FIGS. 4-5 disclose haze reduction, increase in peak crystallization temperature, and haze clarity and gloss improvement in the practice of the invention; and

FIG. 6 shows a comparison of performance of resin which uses PPA and nucleating agent as compared to other resins that do not use both additives.

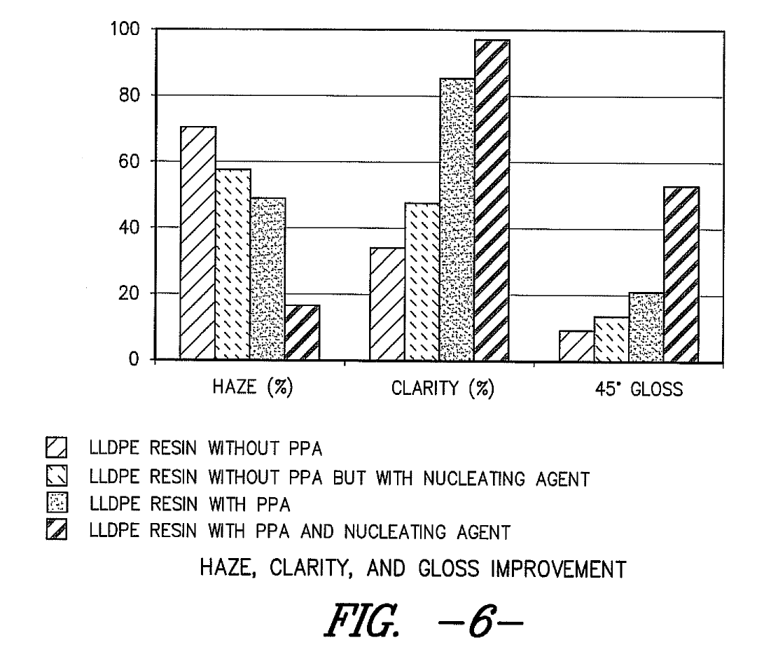

### DETAILED DESCRIPTION OF THE INVENTION

Reference now will be made to the embodiments of the invention, one or more examples of which are set forth below. Each example is provided by way of explanation of the invention, not as a limitation of the invention.

The invention is broadly directed to improvements in optical performance of polyethylene (“PE”) articles, such as PE films, using an additive package consisting of at least a PPA and a nucleating agent. In the application of the invention, a combination concentrate of polymer processing additive (“PPA”) and a nucleator in a single concentrate may result in a more cost effective solution to the problem of high quality film manufacture. Using the invention, the undesirable effect of “sharkskin” may be avoided, or at least minimized, while optical properties of the produced film are improved further.

In one embodiment, a concentrate can be made by melt compounding on a twin screw extruder by feeding both the nucleating agent additive and the PPA at the same time, and in a single concentrate or masterbatch. Nucleating agents that are effective in polymers (such as for example, polyethylene) in the practice of the invention include, for example, those containing an organic group and a polar group and which are insoluble in the polymer, such as aromatic or alicyclic mono- or poly-acids or salts thereof. It is not always predictable that two compounds will be easily combined into a single masterbatch, but in the practice of the invention it has been found that combining PPA and nucleating agent has worked well.

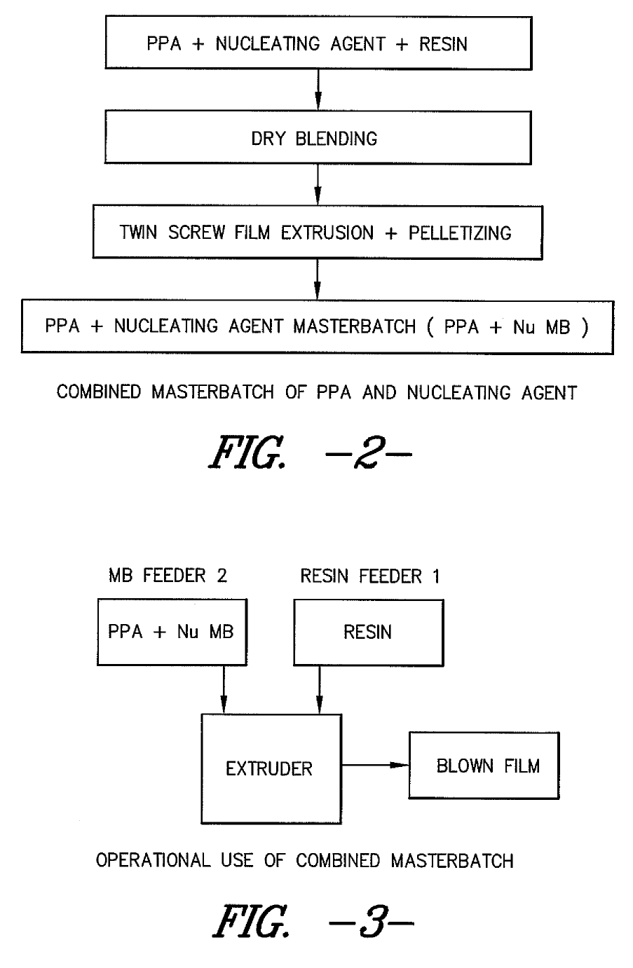

FIG. 2 is a schematic showing the preparation of a single concentrate or masterbatch in the practice of one embodiment of the invention that contains both a PPA and a nucleating agent in a resin for addition in extrusion operations. The additives may be dry blended and then applied as by twin screw film extrusion and/or optional pelletizing to form a combined masterbatch. There are advantages to using a single masterbatch with one feed input line as compared to using two separate masterbatch feed input lines. For example, a combined PPA nucleator with masterbatch provides economy in that operators only need to maintain one SKU or stock number instead of two SKU's as in the case of multiple concentrates. Thus, the efficiency of the blown film line operation is increased. Furthermore, it costs less to make or use a single masterbatch, in most applications. Less amount of masterbatch is needed to introduce the additives, which can also result in operational efficiencies. On the blown film line, the use of a single combined masterbatch can result in only one feeder needed to dose (i.e. apply) the masterbatch, which can save on capital equipment costs and maintenance costs. Further, there is less chance for dosing errors (which can be catastrophic) when using one masterbatch instead of multiple masterbatches for the application of both PPA and nucleating agent additive.

It is known that each time an operator of a resin operation adds another materbatch to the operation, it introduces more carrier material into the system, which can affect material properties in a negative manner. A combined masterbatch can be “tailor made” or customized to match customer demands. Thus, the effectiveness of using a single concentrate is shown by way of the invention.

In the invention, a carrier is used with additives to make a concentrate. The carrier may be comprised of: polyethylenes, polyethylene blends, mineral oils, liquid silicone. In some applications, the masterbatch may be a liquid masterbatch, that is, a concentrate based on a mineral oil or silicone product. In this case, the active additive ingredients may be dissolved or dispersed in the liquid. The liquid could be a substitute for LDPE, in some instances. That is, although polyethylene is a very favorable carrier for the additive package, these other options could be practiced in the invention.

One embodiment of the invention may be comprised of a concentrated polymer masterbatch composition comprising: (a) low density polyethylene; (b) a nucleating agent the following compound:

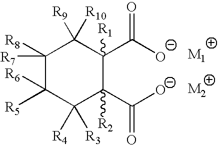

wherein M₁ and M₂ are the same or different and may be combined into one cation, and are selected from at least one metal cation of calcium, strontium, lithium, and monobasic aluminum; and
wherein R₁, R₂, R₃, R₄, R₅, R₆, R₇, R₈, R₉, and R₁₀ are either the same or different and are individually selected from the group consisting of hydrogen, C₁-C₉ alkyl, hydroxy, C₁-C₉ alkoxy, C₁-C₉ alkyleneoxy, amine, and C₁-C₉ alkylamine, halogens, and phenyl, wherein said metal salt compound is provided at a concentration level in the masterbatch of between about 0.1 and 95% by weight. Furthermore, a fluoropolymer processing additive is provided in the masterbatch at a concentration level of between about 0.1 and 95 percent by weight.

In yet another embodiment of the invention, a concentrated polymer concentrate composition comprising:

(a) linear low density polyethylene (LLDPE);

(b) a nucleating agent, such as that provided below as one example:

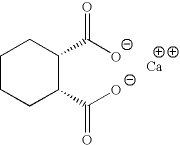

wherein said nucleating agent additive is provided in the concentrate in a concentration of about 0.1 to 95% by weight; and

(c) a fluoropolymer processing additive, said fluoropolymer processing additive being provided in the concentrate in a concentration of about 0.1 to 95% by weight.

The invention also may involve a method of making a PE film comprising the steps of:

(a) providing a polyethylene or polyethylene blend;

(b) mixing with said polyethylene or polyethylene blend a first concentrate composition, said first concentate composition being comprised of:
i) polyethylene,
ii) a nucleating agent, such as Ca HHPA as one example, and
iii) a polymer processing additive, said additive being selected from the group of fluoropolymers, fluorinated elastomers, silicone-containing compounds, phosphate antioxidants, and metal stearates; and

(c) manufacturing a blown PE film.

Some applications of the invention may employ a one-pack, which is a non-dusting blend including a concentrate with very high levels of additive. This may include additive levels of greater than 50% bound together by low melting materials, such as a wax or wax-like binder. This may be applied in a polyethylene production plant.

### The Polymer

The polymer employed may be polyethylene. Linear low density polyethylene (LLDPE) is used in one embodiment of the invention. In other embodiments, blends of several different grades of polyethylene may be employed, such as LDPE (low density polyethylene), HDPE (high density polyethylene) or even polypropylene (PP).

### The PPA

The polymer processing additive (PPA) employed in the invention may consist of a fluoropolymer (such as a fluorinated elastomer), copolymers of vinylidene fluoride and hexafluoropropylene (i.e. a fluoroelastomer), hexafluoropropene, chlorotrifluoroethylene, tetrafluoroethylene, silicone-based additives, including polydimethyl siloxane oils (PDMS II), phosphate antioxidants, metal stearates and perhaps other lubricating or processing aid compounds.

One effective fluoropolymer is Dynamar brand “FX 5911”, which is a fluoropolymer distributed by Dyneon, a 3M Company. This compound is a free flowing granular material, with a melting point of about 100 to 126 degrees C., and a particle size for 98% of particles less than about 2400 microns. This fluoropolymer may be applied in a masterbatch, along with the desired nucleating agent, as shown in examples herein.

The concentration of PPA used in the final film may vary between about 50 ppm and about 5000 ppm. However, in the concentrated masterbatch, the concentration may be provided at a level of about 0.1-95% by weight of the concentrate. In other masterbatch concentrates, the PPA concentration may be at about 1-2% by weight, in specific applications.

### The Nucleating or Clarifying Agent

Effective nucleating or clarifying agents to employ in the practice of the invention include those containing an organic group and a polar group and which are insoluble in the polyethylene, such as aromatic or alicyclic mono- or poly-acids or salts thereof. A particularly effective nucleating agent is HPN-20E manufactured and sold by Milliken & Company (cyclohexanedicarboxylic acid, calcium salt), as shown and described herein (also referred to herein as “Ca HHPA”). Also, an acrylic may be used as well.

When it is employed in the invention, the Ca HHPA may be present in the final film in an amount of between 1 and 10,000 ppm, and also advantageously between 10 and 5000 ppm, and in other embodiments at a concentration of between 50 and 2000 ppm, and in certain other embodiments between about 200 and 1200 ppm. One desirable concentration for such Ca HHPA in film is at about 500 ppm.

However, the concentration of nucleating agent or clarifier in the masterbatch, which is applied in a feedstream to the polymer, is usually much higher. The masterbatch concentration of Ca HHPA is typically higher than 1000 ppm. The concentration in the masterbatch may be about 0.1-95% by weight, and in other more specific embodiments, about 24% by weight of the concentrated masterbatch.

Dispersing agents can be added to help disperse the nucleating agent in the film. Examples of dispersing agents that may be employed include DHT-4A (hydrotalcite), amorphous silica and calcium carbonate, In one embodiment of the invention, a linear low density polyethylene (LLDPE) with a melt flow rate of 12 (gram/10 min) with an additive package consisting of antioxidants such as 500 ppm Irganox 1010 and 1000 ppm Irgafos 168 and acid scavenger such as 2% by weight zinc stearate and about 4% by weight of a nucleating agent composition (Ca HHPA). Further, about 2% by weight of a PPA compound (FX-5911; fluoropolymer) also was added. These components were high-intensity blended and melt-compounded on a twin screw extruder. A silica-based material also may be added in a concentration of about 1% (weight percent), as an optional ingredient of the masterbatch.

The concentrates made herein were provided into (i.e. “let down”) into an extrusion grade linear low density polyethylene (LLDPE) resin. One convenient manner of performing the method of the invention is by way of a single masterbatch feedstream that is provided to apply this masterbatch into a stream of LLDPE, so that the additives are easily and quickly dispersed in the polymer, for application in extrusion, or making of film, or the like.

### EXAMPLE 1

### PPA Fluoropolymer with HPN-20E Nucleating Agent

FIG. 5 shows haze values of films made using a single concentrate containing both a PPA (2% by weight for the PPA concentrate and 1% for the combined concentrate) and a nucleating or clarifying agent (2% by weight) added to a LLDPE polymer. The control sample showed relatively severe melt fracture under the processing conditions. When the PPA was added, a reduction in haze is observed and the melt fracture is reduced significantly. Also a significant reduction in die pressure was observed. In this example, the PPA compound used was fluorinated elastomer.

In this example, when using a combination of both a PPA and a nucleator (HPN20E in this instance) lower haze values are obtained than when using a masterbatch stream containing PPA with no clarifying agent. There is a significant advantage to using a PPA and a nucleating agent together.

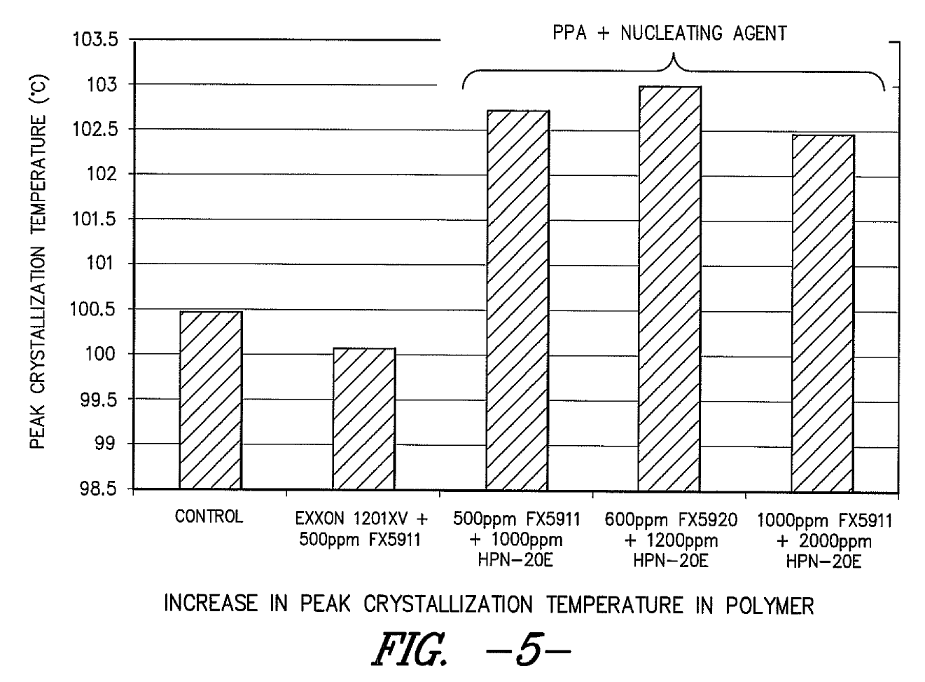

Furthermore, the peak crystallization temperature increases when using a single masterbatch with both PPA and clarifying agent in the masterbatch, as compared with the non-nucleated control and also the sample made using only a PPA. This result is shown in FIG. 4. Thus, the use of the invention provides opportunities for increased output on cooling limited blown film lines. Together with the nucleating agent, the use of both a PPA and a clarifying/nucleating agent has significant advantages. FIG. 5 shows haze, clarity, and gloss improvements when using the combined masterbatch in LLDPE resin.

### EXAMPLE 2

### Extrusion of a Film Using Combined Masterbatch

A blown film line (extruder: E20T and blown film unit type BL50T) from Dr. Collin, GMBH was used, as indicated below: The screw diameter was 20 mm. A suitable screw configuration for polyolefins was used with compression of 3.08. The extruder was equipped with a blown film die, diameter 30 mm and a die gap of 0.5 mm. The BUR was 2.5 and the thickness of the films was targeted at 30 micron. The extruder temperatures were as in Table 1 herein. A single masterbatch (concentrate) with PPA and also nucleating agent was employed.

TABLE 1
Parameters for Extruder Zones in Degrees Centigrade

| Zone 1 | Zone 2 | Zone 3 | Adapter | |
|---|---|---|---|---|
| [° C.] | [° C.] | [° C.] | [° C.] | Die [° C.] |
| 160 | 170 | 190 | 180 | 180 |

The optical performance of the variant with the PPA and the HPN20E nucleator showed the best optical performance. It is believed that PPA reduces the macro size roughness and that HPN-20E reduces the micro-size roughness and the bulk haze of the LLDPE films. This results in a beneficial synergistic effect upon the optical performance of the LLDPE films at two different length scales. It has been found that the use of these two components in a single masterbatch is a very efficient and effective manner of making polymer articles, and especially, extruded polymer articles.

1. (canceled)

2. (canceled)

3. A concentrated polymer masterbatch composition comprising:
(a) low density polyethylene;
(b) a metal salt compound: 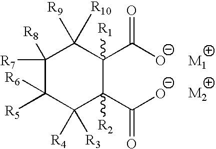
wherein M₁ and M₂ are the same or different and may be combined into one cation, and are selected from at least one metal cation of calcium, strontium, lithium, and monobasic aluminum; and
wherein R_{1,} R_{2,} R_{3,} R_{4,} R_{5,} R_{6,} R_{7,} R_{8,} R_{9,} and R₁₀ are either the same or different and are individually selected from the group consisting of hydrogen, C₁-C₉ alkyl, hydroxy, C₁-C₉ alkoxy, C₁-C₉ alkyleneoxy, amine, and C₁-C₉ alkylamine, halogens, and phenyl,
wherein said metal salt compound is provided at a concentration level in the masterbatch of between about 0.1 - 95% by weight; and
(c) a fluoropolymer processing additive, said fluoropolymer processing additive being provided in the masterbatch at a concentration level of about 0.1 - 95 percent by weight.

4. A concentrated polymer masterbatch composition comprising:
(a) linear low density polyethylene (LLDPE);
(b) a nucleating agent having a structure: 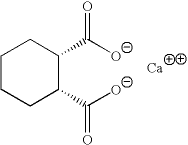
wherein said nucleating agent is provided in the masterbatch in a concentration of about 0.1 - 95% by weight; and
(c) a fluoropolymer processing additive, said fluoropolymer processing additive being provided in the masterbatch in a concentration of about 0.1 - 95% by weight.

5-8. (canceled)

9. The concentrated polymer masterbatch composition of claim 3, wherein the fluoropolymer processing additive is present in the masterbatch in a concentration level of about 1.-2% by weight.

10. The concentrated polymer masterbatch composition of claim 4, wherein the fluoropolymer processing additive is present in the masterbatch in a concentration of about 1-2% by weight.

11. The concentrated polymer masterbatch composition of claim 3, wherein the metal salt compound is present in the masterbatch in a concentration level of about 2-4% by weight.

12. The concentrated polymer masterbatch composition of claim 4, wherein the nucleating agent is present in the masterbatch in a concentration of about 2-4% by weight.

13. The concentrated polymer masterbatch composition of claim 3, wherein the masterbatch further comprises a dispersing agent.

14. The concentrated polymer masterbatch composition of claim 13, wherein the dispersing agent is selected from the group consisting of hydrotalcite, amorphous silica, and calcium carbonate.

15. The concentrated polymer masterbatch composition of claim 4, wherein the masterbatch further comprises a dispersing agent.

16. The concentrated polymer masterbatch composition of claim 15, wherein the dispersing agent is selected from the group consisting of hydrotalcite, amorphous silica, and calcium carbonate.
